(19) United States
(12) Patent Application Publication
(10) Pub. No.: US 2004/0081263 A1
(43) Pub. Date: Apr. 29, 2004

(54) Method and apparatus for receiving diversity transmissions

(76) Inventors: King F. Lee, Schaumburg, IL (US); Douglas Bennett Williams, Decatur, GA (US)

Correspondence Address: POSZ & BETHARDS, PLC, 11250 ROGER BACON DRIVE, SUITE 10, RESTON, VA, 20190, US

(21) Appl. No.: 10/279,659

(22) Filed: Oct. 24, 2002

(51) Int. Cl. H04L 1/02

(52) U.S. Cl. 375/347

(57) ABSTRACT

A receiver (112, 412) and method for receiving signals within a system of space-frequency or space-time orthogonal frequency division multiplexed signals (OFDM) for transmitter diversity includes a signal processor (123, 423) for restoring a cyclic property to these signals to provide a reconstructed output signal. The signal processor (123, 423) performs cyclic reconstruction on the received signal based on channel impulse estimates and an iterative recovery process.

### FIELD OF THE INVENTION

The present invention relates generally to communication systems, and, more specifically, to a method and device for receiving bandwidth efficient diversity transmissions.

### BACKGROUND OF THE INVENTION

Multipath fading is a major impairment in mobile communications. Signal fading caused by multipath fading significantly degrades the performance and reliability of mobile communication systems. Receiver spatial diversity is a well-known technique for combating the detrimental effect of multipath fading. Unfortunately, receiver diversity requires multiple widely spaced antennas and multiple front-end circuits at the receivers, which may be undesirable or impractical for portable devices such as pagers or cellular handsets. Transmitter diversity, on the other hand, can be implemented with multiple antennas at the base station and only requires a single antenna and front-end circuit at the receiver. Transmitter diversity techniques are therefore often more suitable for paging, cellular and wide-area wireless data networks and subscriber equipment. Furthermore, the channels over which high data rate systems operate are generally frequency selective, so transmitter diversity techniques that are effective in frequency selective fading channels are crucial.

Orthogonal frequency division multiplexing (OFDM) transmitter diversity techniques have been proposed and shown to provide near optimal diversity gain in frequency selective fading channels. However, the conventional OFDM transmitter diversity techniques that provide good diversity gain require a cyclic prefix in the preceding and decoding processes to achieve good diversity performance in frequency selective fading channels. The use of the cyclic prefix increases channel overhead and thus can result in a significant loss of valuable resources such as channel capacity or bandwidth. If the cyclic prefix is simply eliminated, inter-symbol interference (ISI) and inter-channel interference (ICI) arise in the transmitted OFDM signal. As a result, the diversity performance or diversity gain of the OFDM transmitter diversity system is significantly degraded.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of a preferred embodiment of an Iterative Space Frequency OFDM transmitter diversity system.

FIG. 2 is a flow diagram of a preferred embodiment for achieving Iterative Space Frequency OFDM transmitter diversity.

FIG. 3 is a graph illustrating various performances obtained for various Space Frequency OFDM transmitter diversity techniques.

FIG. 4 is a block diagram of a preferred embodiment of an Iterative Space Time OFDM transmitter diversity system.

FIG. 5 is a flow diagram of a preferred embodiment for achieving Iterative Space Time OFDM transmitter diversity.

FIG. 6 is a graph illustrating various performances obtained for various Space Time OFDM transmitter diversity techniques.

### DETAILED DESCRIPTION OF THE PREFERRED EXEMPLARY EMBODIMENTS

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the preferred embodiments.

OFDM is an effective modulation technique for frequency selective channels and is increasingly being deployed in or considered for high data rate systems. Space-time and space-frequency coded OFDM systems can provide near optimal diversity gain in frequency selective fading channels. However, these techniques all require a cyclic prefix that includes a number of symbols to be added to the transmitted symbols. The number of cyclic prefix symbols in the cyclic prefix is normally equal to or greater than the order (L) of the channel. The cyclic prefix transforms a linear convolution between transmitted symbols and a frequency selective channel impulse response into circular convolution. An inverse discrete Fourier transform (IDFT) and a discrete Fourier transform (DFT) pair used in OFDM modulation and demodulation processes advantageously transform a time domain circular convolution into a simple multiplication in the frequency domain. The net effect is that OFDM with a cyclic prefix transforms the frequency selective fading channel into multiple perfectly flat fading subchannels. The space-time and space-frequency coded OFDM (ST-OFDM and SF-OFDM) transmitter diversity techniques take advantage of this special property of OFDM with a cyclic prefix in the precoding and decoding processes to achieve good diversity performance at a favorable processing load.

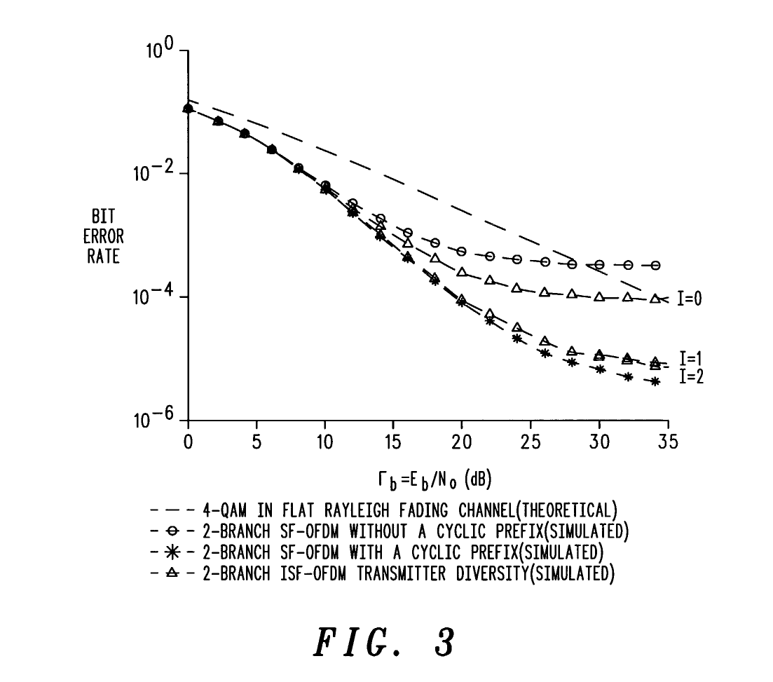

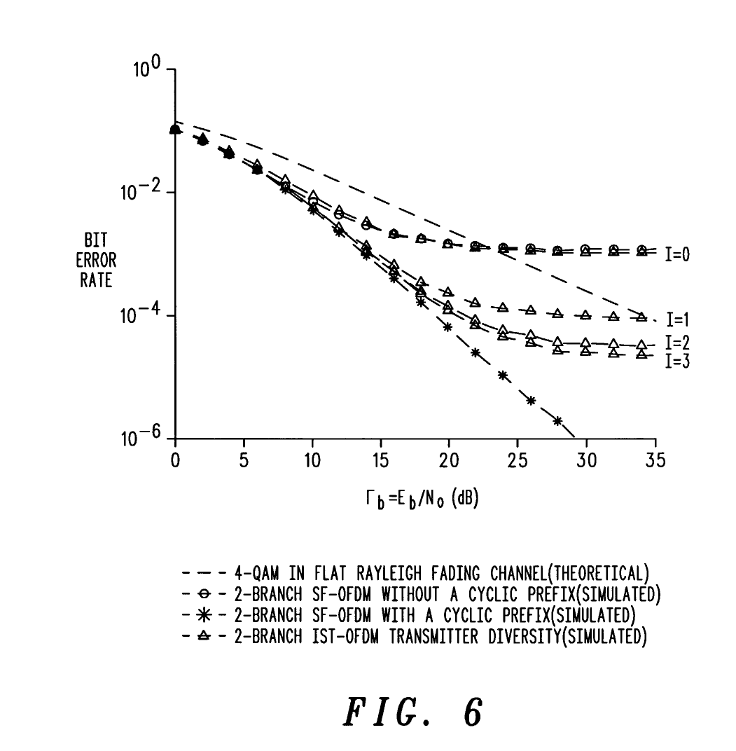

However, as noted earlier in passing, the use of the cyclic prefix can result in a significant loss of valuable channel resources. For example, the addition of the cyclic prefix will cause bandwidth expansion if a desired data rate is to be maintained, or a reduction in data rate if the transmission bandwidth is fixed. For example, a high data rate system with a block size (N) of 32 and a channel order (L) of 5 would require a cyclic prefix of length 5 and would result in a bandwidth expansion of L/N=15.6%. If the cyclic prefix is simply eliminated, the convolution between the transmitted symbols and the frequency selective channel impulse response reverts back to the usual linear convolution, and inter-symbol interference (ISI) and inter-channel interference (ICI) in the OFDM signal cannot be resolved. As a result, the OFDM subchannels as processed at a receiver are no longer flat fading and the diversity performance of the space-time and space-frequency coded OFDM transmitter diversity systems are significantly degraded. For example, referring to FIG. 3, simulated bit error rate (BER) performance results of an SF-OFDM transmitter diversity system are shown with and without a cyclic prefix. FIG. 3 clearly shows the degradation of the diversity gain for the SF-OFDM without a cyclic prefix versus the higher quality or lower BER obtained when the cyclic prefix is included. FIG. 6 shows similar results for the diversity gain of ST-OFDM with and without the cyclic prefix.

Other techniques have been proposed to reduce the negative effects of ISI and ICI in the OFDM signal. These techniques are generally channel specific in that the equalizer coefficients are functions of the channel response. The channel responses between each transmitter and the receiver in transmitter diversity systems are different. An equalizer that simultaneously equalizes the responses from all the transmitters does not exist in general. Therefore, any ISI and ICI compensation technique that is channel response specific will not be effective for transmitter diversity systems.

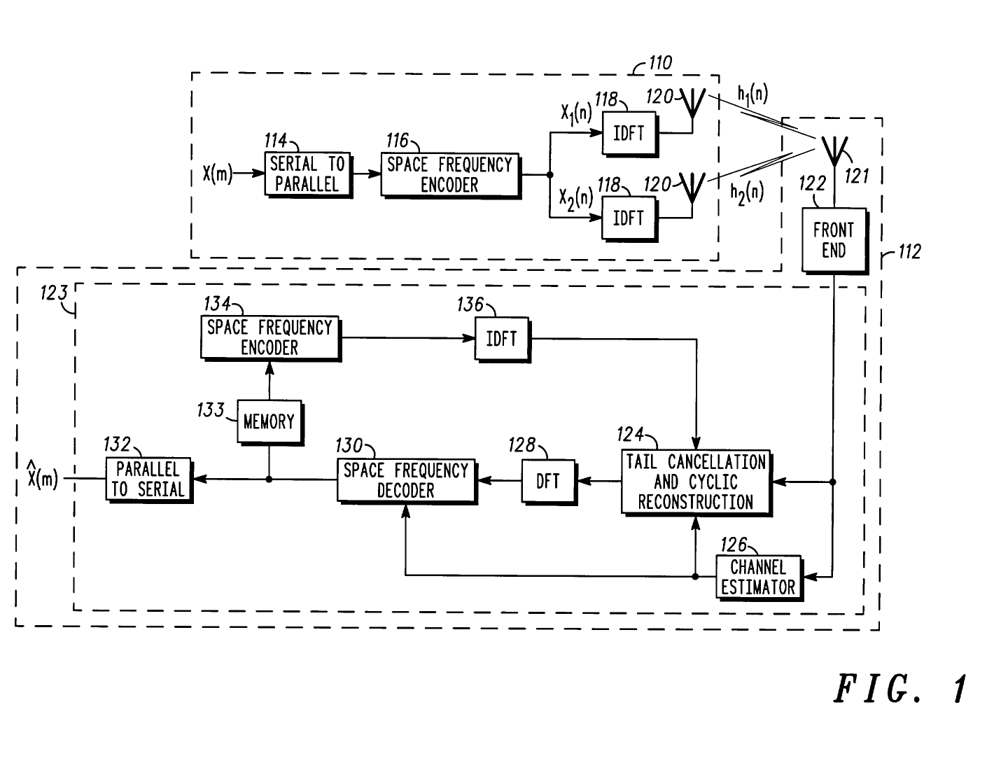

Referring now to the drawings in which like reference numerals refer to like elements, FIG. 1 shows a block diagram of an Iterative Space-Frequency OFDM transmitter diversity system (system) according to the present invention. The system includes a space-frequency diversity transmitter 110 and a receiver 112, each of which will be discussed in more detail below. The system may be, for example, an IEEE 802.11 wireless local area network.

The space-frequency (SF) diversity transmitter 110 includes a serial to parallel device 114, a space-frequency (SF) encoder 116, a plurality of inverse discrete Fourier transform (IDFT) devices 118 and a plurality of transmitters 120 (depicted as antenna elements) for transmitting a plurality of time domain orthogonal frequency division multiplexed signals. The plurality of transmitters 120 may be or be contained within, for example, an IEEE 802.11 access point or base station, a cellular base station, or the like. The elements of the SF diversity transmitter 110 will be discussed in further detail below.

N input serial data symbols X(m) that each have a symbol duration Tₛ are collected by the serial to parallel device 114 and converted into a data vector X(n)=[X(nN), X(nN+1) . . . X(nN+N−1)]^{T}, which has a block duration of NTₛ. The SF encoder 116 space frequency encodes the data vector X(n) into K vectors X₁(n), X₂(n) . . . X_{K}(n), in which K represents the number of transmitters 120. The encoding is done by SF encoding techniques which are explained, for example, in “A Space-Frequency Transmitter Diversity Technique for OFDM Systems” in Proc. IEEE GLOBECOM, San Francisco, Calif., November-December 2000, vol. 3, pp. 1473-1477 authored by Lee et al. (the inventors of the present invention). The contents of this publication are incorporated herein by reference. Although only two vectors (two transmitters, etc.) are shown in FIG. 1, it should be understood that the SF encoder 116 can be utilized to encode X(n) into K vectors. The required performance versus economics of additional transmitters and processor requirements of the receiver will guide a particular system design. Here, two vectors X₁(n) and X₂(n) are shown as a practical system and for ease of illustration. An inverse discrete Fourier transformation is performed on each of the space-frequency encoded vectors X₁(n), X₂(n) . . . X_{K}(n) by a respective one of the plurality of IDFT devices 118, which converts them into time domain OFDM signals x₁(n), x₂(n) . . . x_{K}(n). Each of the time domain OFDM signals x₁(n), x₂(n) . . . x_{K}(n) is subsequently transmitted by a respective one of the plurality of transmitters 120 over a respective one of the, here 2, but generally K channels, each of which has a channel impulse response h₁(n), h₂(n) . . . h_{K}(n), respectively. It should be noted that no cyclic prefix is added to the time domain OFDM signals x₁(n), x₂(n) . . . x_{K}(n), thus advantageously eliminating or avoiding bandwidth expansion.

The receiver 112 includes an antenna device 121 coupled to a receiver front end 122 for receiving the time domain OFDM signals as a received signal r(n). As understood by those skilled in the art, the antenna device 121 absorbs the time domain OFDM signals and the receiver front end 122 provides signal amplification, RF selectivity, down conversion to a baseband frequency and analog to digital conversion, among other functions. The receiver front end 122 is connected to a signal processor 123 in the receiver 112. The signal processor 123 includes a channel estimator 126 for estimating the channel impulse response ĥ₁(n),ĥ₂(n) . . . ĥ_{K}(n) for each of the channels that carried the time domain OFDM signals. The signal processor 123 further includes, all intercoupled as depicted, a tail cancellation and cyclic reconstruction device (tail cancellation device) 124 in communication with the channel estimator 126 for performing a tail cancellation operation on the received signal and for generating a resultant signal \tilde{r}(n), a discrete Fourier transform (DFT) device 128 for performing a discrete Fourier transformation (DFT) on the resultant signal \tilde{r}(n) to generate a transformed resultant signal vector, a space-frequency decoding device 130 (will be described more later) for decoding the transformed resultant signal vector to generate an estimate of the output signal \hat{X}(n), a parallel to serial device 132 for converting the estimate (in a final form) to output serial data symbols, a memory source 133 for providing temporary storage of the estimate, a space-frequency encoding device 134 for encoding an estimate of a previous output signal \hat{X}(n−1) to generate K space-frequency encoded previous estimate vectors \hat{X}₁(n−1),\hat{X}₂(n−1) . . . \hat{X}_{K}(n−1)and for encoding the estimate of the output signal \hat{X}(n) to generate K space-frequency encoded estimate vectors \hat{X}₁(n), \hat{X}₂(n) . . . \hat{X}_{K}(n), and an inverse discrete Fourier transform (IDFT) device 136 for performing an inverse discrete Fourier transformation on the K encoded estimate vectors of the previous output signal \hat{X}₁(n−1), \hat{X}₂(n−1) . . . \hat{X}_{K}(n−1) to generate K transformed previous estimate vectors \hat{x}₁(n−1), \hat{x}₂(n−1) . . . \hat{x}_{K}(n−1) and for performing an inverse discrete Fourier transformation on the K encoded estimate vectors of the output signal \hat{X}₁(n), \hat{X}₂(n) . . . \hat{X}_{K}(n) to generate K transformed estimates \hat{x}₁(n), \hat{x}₂(n) . . . \hat{x}ₖ(n). As appreciated by those skilled in the art, the receiver 112 will include further processing operations such as error decoding, interfacing, and the like for providing information suitable for consumption or utilization by a user or other entity requiring the information.

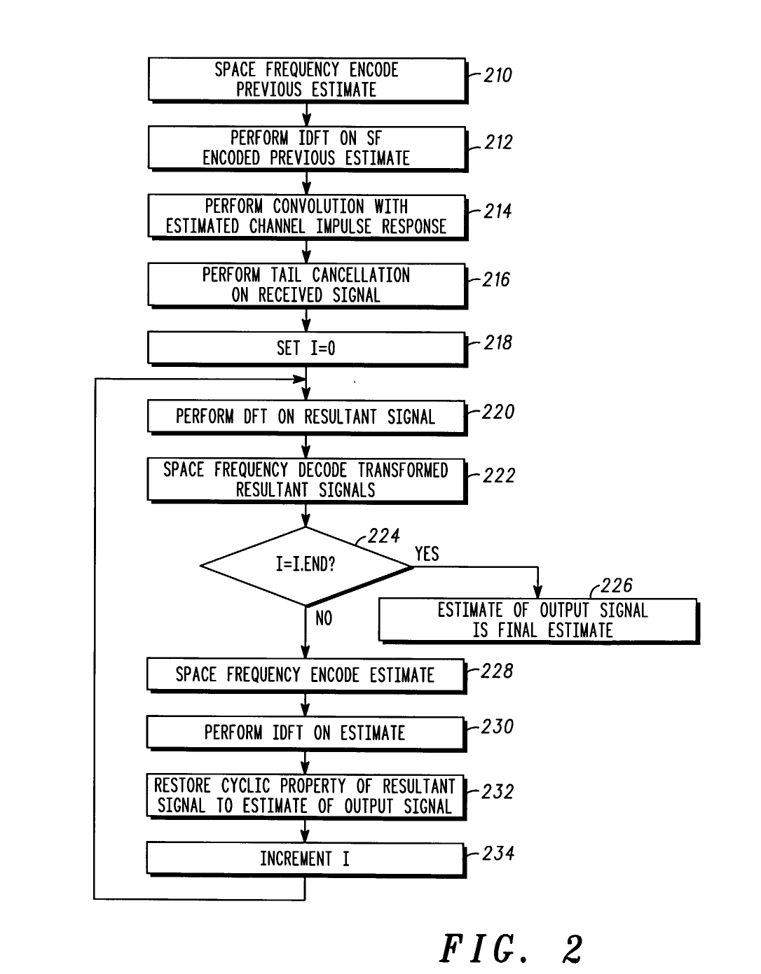

Operation of the receiver 112 will be referred to as the Iterative Space-Frequency Orthogonal Frequency Division Multiplexing process (ISF-OFDM) and will be more fully discussed with reference to FIG. 2.

Initially, at 210 the space-frequency encoding device 134 space-frequency encodes an estimate of a previous output signal \hat{X}(n−1) to generate up to K space-frequency encoded previous estimate vectors \hat{X}₁(n−1), \hat{X}₂(n−1) . . . \hat{X}_{K}(n−1). Operation of the space-frequency encoding device 134 of the signal processor 123 is similar to that of the space-frequency encoding device 116 of the transmitter 110.

At 212, the inverse discrete Fourier transform device 136 performs an inverse discrete Fourier transformation on the space-frequency encoded previous estimate vectors \hat{X}₁(n−1), \hat{X}₂(n−1) . . . \hat{X}_{K}(n−1) to generate K transformed previous estimate vectors \hat{x}₁(n−1), \hat{x}₂(n−1) . . . \hat{x}_{K}(n−1), which are provided to the tail cancellation device 124 for the tail cancellation operation.

At 214, the tail cancellation device 124 and the channel estimator 126 receive the plurality of time domain OFDM signals as a received signal r(n) from the receiver front end 122. The received signal r(n) can be expressed mathematically in terms of convolution matrices and vectors by equation (1):

r(n)=H_{1,0}x₁(n)+H_{1,1}x₁(n−1)+H_{2,0}x₂(n)+H_{2,1}x₂(n−1)+ . . . H_{k,0}xₖ(n)+H_{k,1}xₖ(n−1); (1)

or

$$r ( n ) = {\sum }_{k = 1}^{K} {H}_{k , 0} {x}_{k} ( n ) + {H}_{k , 1} {x}_{k} ( n - 1 )$$

As described later, estimates of the channel impulse response matrices H_{x,y} are provided by the channel estimator 126. The first index in the subscript denotes the spatial dimension and the second index denotes the temporal dimension. The convolution matrices of the channel impulse responses h₁ and h₂are defined as follows:

$${H}_{1 , 0} = [ \begin{matrix}{h}_{1 , 0} & 0 & ⋯ & ⋯ & ⋯ & ⋯ & 0 \\ {h}_{1 , 1} & {h}_{1 , 0} & 0 & ⋰ & ⋰ & ⋰ & ⋮ \\ ⋮ & {h}_{1 , 1} & {h}_{1 , 0} & ⋰ & ⋰ & ⋰ & ⋮ \\ {h}_{1 , L} & ⋰ & ⋰ & ⋰ & ⋰ & ⋰ & ⋮ \\ 0 & ⋰ & ⋰ & ⋰ & {h}_{1 , 0} & 0 & ⋮ \\ ⋮ & ⋰ & ⋰ & ⋰ & {h}_{1 , 1} & {h}_{1 , 0} & 0 \\ 0 & ⋯ & 0 & {h}_{1 , L} & ⋯ & {h}_{1 , 1} & {h}_{1 , 0}\end{matrix} ] , \\ {H}_{1 , 1} = [ \begin{matrix}0 & ⋯ & 0 & {h}_{1 , L} & ⋯ & {h}_{1 , 2} & {h}_{1 , 1} \\ ⋮ & 0 & ⋰ & 0 & ⋰ & ⋰ & {h}_{1 , 2} \\ ⋮ & ⋰ & ⋰ & ⋰ & ⋰ & ⋰ & ⋮ \\ ⋮ & ⋰ & ⋰ & ⋰ & ⋰ & 0 & {h}_{1 , L} \\ ⋮ & ⋰ & ⋰ & ⋰ & ⋰ & ⋰ & 0 \\ ⋮ & ⋰ & ⋰ & ⋰ & ⋰ & 0 & ⋮ \\ 0 & ⋯ & ⋯ & ⋯ & ⋯ & ⋯ & 0\end{matrix} ] , \\ {H}_{2 , 0} = [ \begin{matrix}{h}_{2 , 0} & 0 & ⋯ & ⋯ & ⋯ & ⋯ & 0 \\ {h}_{2 , 1} & {h}_{2 , 0} & 0 & ⋰ & ⋰ & ⋰ & ⋮ \\ ⋮ & {h}_{2 , 1} & {h}_{2 , 0} & ⋰ & ⋰ & ⋰ & ⋮ \\ {h}_{2 , L} & ⋰ & ⋰ & ⋰ & ⋰ & ⋰ & ⋮ \\ 0 & ⋰ & ⋰ & ⋰ & {h}_{2 , 0} & 0 & ⋮ \\ ⋮ & ⋰ & ⋰ & ⋰ & {h}_{2 , 1} & {h}_{2 , 0} & 0 \\ 0 & ⋯ & 0 & {h}_{2 , L} & ⋯ & {h}_{2 , 1} & {h}_{2 , 0}\end{matrix} ] , \\ {H}_{2 , 1} = [ \begin{matrix}0 & ⋯ & 0 & {h}_{2 , L} & ⋯ & {h}_{2 , 2} & {h}_{2 , 1} \\ ⋮ & 0 & ⋰ & 0 & ⋰ & ⋰ & {h}_{2 , 2} \\ ⋮ & ⋰ & ⋰ & ⋰ & ⋰ & ⋰ & ⋮ \\ ⋮ & ⋰ & ⋰ & ⋰ & ⋰ & 0 & {h}_{2 , L} \\ ⋮ & ⋰ & ⋰ & ⋰ & ⋰ & ⋰ & 0 \\ ⋮ & ⋰ & ⋰ & ⋰ & ⋰ & 0 & ⋮ \\ 0 & ⋯ & ⋯ & ⋯ & ⋯ & ⋯ & 0\end{matrix} ] .$$

and generally for the kth channels:

$${H}_{k , 0} = [ \begin{matrix}{h}_{k , 0} & 0 & ⋯ & ⋯ & ⋯ & ⋯ & 0 \\ {h}_{k , 1} & {h}_{k , 0} & 0 & ⋰ & ⋰ & ⋰ & ⋮ \\ ⋮ & {h}_{k , 1} & {h}_{k , 0} & ⋰ & ⋰ & ⋰ & ⋮ \\ {h}_{k , L} & ⋰ & ⋰ & ⋰ & ⋰ & ⋰ & ⋮ \\ 0 & ⋰ & ⋰ & ⋰ & {h}_{k , 0} & 0 & ⋮ \\ ⋮ & ⋰ & ⋰ & ⋰ & {h}_{k , 1} & {h}_{k , 0} & 0 \\ 0 & ⋯ & 0 & {h}_{k , L} & ⋯ & {h}_{k , 1} & {h}_{k , 0}\end{matrix} ] , \\ {H}_{k , 1} = [ \begin{matrix}0 & ⋯ & 0 & {h}_{k , L} & ⋯ & {h}_{k , 1} & {h}_{k , 1} \\ ⋮ & 0 & ⋰ & 0 & ⋰ & ⋰ & {h}_{k , 2} \\ ⋮ & ⋰ & ⋰ & ⋰ & ⋰ & ⋰ & ⋮ \\ ⋮ & ⋰ & ⋰ & ⋰ & ⋰ & 0 & {h}_{k , L} \\ ⋮ & ⋰ & ⋰ & ⋰ & ⋰ & ⋰ & 0 \\ ⋮ & ⋰ & ⋰ & ⋰ & ⋰ & 0 & ⋮ \\ 0 & ⋯ & ⋯ & ⋯ & ⋯ & ⋯ & 0\end{matrix} ]$$

H_{k,0} will be referred to as a first convolution component of the channel impulse response for the kth channel and H_{k,1} will be referred to as a second convolution component of the channel impulse response for the kth channel. K represents the number of transmitters 120 and k=1, . . . , K. L represents the channel order.

The channel estimator 126 estimates the channel impulse response ĥ₁(n), ĥ₂(n) . . . ĥₖ(n) for each of the K channels that carry the respective one of the K time domain orthogonal frequency division multiplexed signals and determines the first and second convolution components for each of the estimated channel impulse responses in accordance with the convolution matrices disclosed above. The channel estimating operation can done as disclosed in the publication entitled “Channel Estimation for OFDM Systems with Transmitter Diversity in Mobile Wireless Channels” in IEEE J. Select. Areas Commun., vol. 17, no. 3, pp. 461-471, March 1999 authored by Li et al and also as disclosed in the publication entitled “Pilot-symbol-assisted Channel Estimation for Space-Time Coded OFDM Systems,” in EURASIP Journal on Applied Signal Processing, vol. 2002, no. 5, pp. 507-516, May 2002 authored by Lee et al. (the inventors of the present invention). The contents of these publications are incorporated herein by reference.

At 216, the tail cancellation device performs a tail cancellation operation on the received signal based upon the first and second convolution components for each of the K estimated channel impulse responses determined by the channel estimator 126 and the K transformed previous estimate vectors \hat{x}₁(n−1), \hat{x}₂(n−1) . . . \hat{x}ₖ(n−1) provided by the IDFT device 136 and generates a resultant signal \tilde{r}(n). Generally, the tail cancellation device 124 performs the tail cancellation operation on the received signal and generates the resultant signal \tilde{r}(n) in accordance with equation (2):

$$\tilde{r} ( n ) = r ( n ) - {\sum }_{k = 1}^{K} {\hat{H}}_{k , 1} {\hat{x}}_{k} ( n - 1 ) \qquad ( 2 )$$

\tilde{r}(n) represents the resultant signal, r(n) represents the received signal, Ĥ_{k,1} represents the second convolution component of the channel impulse response estimated by the channel estimator 126 for one of the K channels that carries a respective one of the plurality of time domain OFDM signals, and \hat{x}ₖ(n−1) represents a transformed previous estimate vector for one of the plurality of time domain OFDM signals.

Referring back to equation (1), the term H_{k,1}xₖ(n−1) represents contributions from a previous received signal. These terms are estimated and eliminated (tail cancellation) by the transformed previous estimate vectors \hat{x}₁(n−1), \hat{x}₂(n−1), . . . , \hat{x}ₖ(n−1) and second convolution components for each of the K estimated channel impulse responses.

At 218, a control iterator I is initialized to zero. Because of the iterative nature of the ISF-ODM process, the control iterator I is necessary for keeping track of the number of iterations performed. The control iterator I may be stored, for example, in the tail cancellation device 124.

At 220, the DFT device 128 performs the discrete Fourier transformation on the resultant signal \tilde{r}(n) and generates a transformed resultant signal vector.

At 222, the SF decoder 130 space-frequency decodes 130 the transformed resultant signal vector to generate an estimate of the output signal \hat{X}(n). The space-frequency decoding operation is explained in, for example, “A Space-Frequency Transmitter Diversity Technique for OFDM Systems”, supra. At 224, the control iterator I is checked to see if its value is I.END. I.END is an integer value that determines the number of iterations. The number of iterations may be, for example, three. The number of iterations should be in accordance with the desired accuracy. If the value of the control iterator is I.END, the process proceeds to 226, where the estimate of the output signal is treated as the final estimate and a copy of this final estimate is stored in the memory source 133. If the value of the control iterator is less than I.END, the process proceeds to 228.

At 228, the SF encoding device 134 SF encodes the estimate of the output signal \hat{X}(n) to generate K encoded estimates \hat{X}₁(n), \hat{X}₂ (n) . . . \hat{X}ₖ(n).

At 230, the IDFT device 136 performs an inverse discrete Fourier transformation on the K encoded estimates of the output signal \hat{X}₁(n), \hat{X}₂(n) . . . \hat{X}ₖ(n) to generate K transformed estimates \hat{x}₁(n), \hat{x}₂(n), . . . \hat{x}ₖ(n).

At 232, the tail cancellation device 124 restores a cyclic property to the resultant signal estimate and generates a reconstructed signal in accordance with equation (3):

$${y}^{( I )} ( n ) = \tilde{r} ( n ) + {\sum }_{k = 1}^{K} {\hat{H}}_{k , 1} {\hat{x}}_{k}^{( I )} ( n ) \qquad ( 3 )$$

y⁽¹⁾(n) represents the reconstructed received signal, \hat{x}ₖ⁽¹⁾(n) represents the K transformed estimates and I represents the present iteration status of the control iterator for the predetermined number of iterations (I.END) for which the reconstructed signal is recalculated.

At 234, the control iterator is incremented by one and the process loops back to 220, where the reconstructed signal y⁽¹⁾(n) is treated as a resultant signal \tilde{r}(n).

The parallel to serial device 132 converts the final estimate of the output signal to output serial data symbols in a manner which is inverse of the operation of the serial to parallel device 114 of the SF diversity transmitter 110.

The graph of FIG. 3 shows the bit error rate obtained when using the ISF-OFDM process for different number of iterations and also when using the conventional SF-OFDM technique with and without the cyclic prefix. As shown, the present embodiment provides a bit error rate with two iterations that is comparable to that obtained with the conventional SF-OFDM technique with the cyclic prefix. However, the ISF-OFDM obtains this bit error rate without the bandwidth expansion caused by the cyclic prefix.

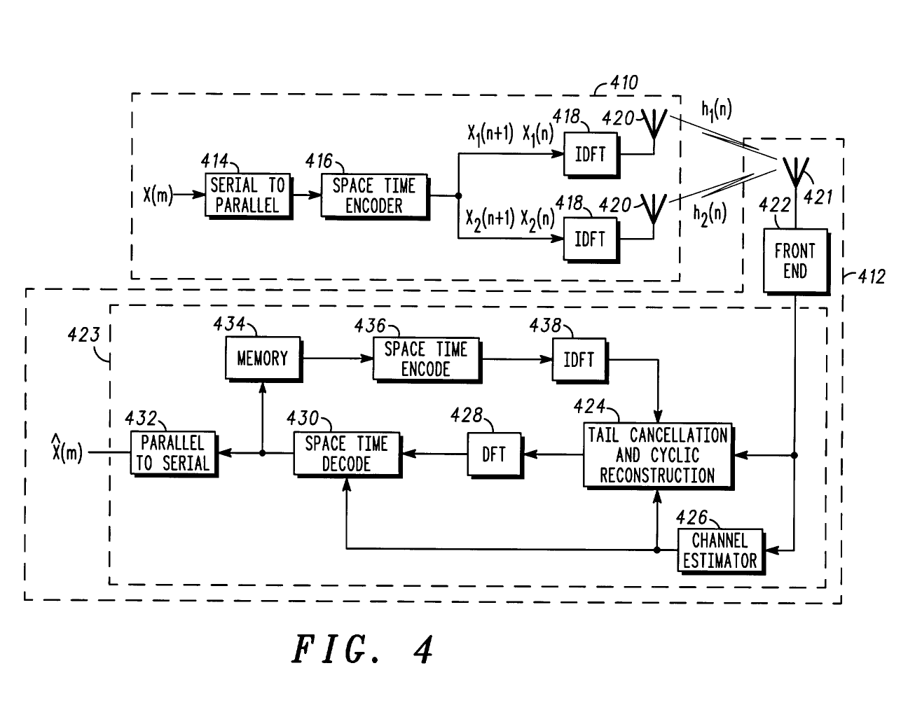

Referring now to FIG. 4, a block diagram of an Iterative Space-Time OFDM transmitter diversity system (system) according to the present invention is shown. The system includes a space-time diversity transmitter 410 and a receiver 412, each of which will be discussed in more detail below.

The space-time diversity transmitter 410 includes a serial to parallel device 414, a space-time (ST) encoder 416, a plurality (K) of IDFT devices 418 and a plurality (K) of transmitters 420 for transmitting a plurality (K) of time domain OFDM signals. The elements of the space-time diversity transmitter 410 will be discussed in detail below.

N input serial data symbols X(m) that each have a symbol duration Tₛ are collected by the serial to parallel device 414 and converted into a data vector X(n)=[X(n,1), X(n,2) . . . X(n,N)]^{T}, which has a block duration of NTₛ in a manner similar to the serial to parallel device 114 of the space-frequency diversity transmitter 110. The ST encoder 416 space-time encodes successive P data vectors X(n),X(n+1), . . . X(n+P−1) outputted from the serial to parallel device 414 into K blocks [X₁(n),X₁(n+1) . . . X₁(n+P−)], . . . [X_{K}(n), X_{K}(n+1), . . . X_{K}(n+P−1)] according to a known ST encoding scheme, such as that disclosed in “A Space-Time Transmitter Diversity Technique for Frequency Selective Fading Channels” et seq. Although only two vector blocks (two transmitters, etc.) are shown in FIG. 4, it should be understood that the ST encoder 416 will encode the successive data vectors X(n),X(n+1), . . . X(n+P−1) into K vector blocks, in which K is the number of transmitters 420 and P is the temporal extent determined by the particular ST encoding scheme utilized. Here two vector blocks [X₁(n), X₁(n+1)], [X₂(n), X₂(n+1)] in which K=P=2, are shown as a practical implementation and for ease of illustration.

An inverse discrete Fourier transformation is performed on each of the vector blocks [X₁(n),X₁(n+1), . . . X₁(n+P−1)], . . . [X_{K}(n), X_{K}(n+1), . . . X_{K}(n+P−1)] by a respective one of the K IDFT devices 418, which converts the vector blocks into time domain OFDM signal blocks [xₖ(n), xₖ(n+1), xₖ(n+P−1) ] in which k=1,2, . . . K. The time domain OFDM signal blocks [xₖ(n), xₖ(n+1), . . . xₖ(n+P−1)] are subsequently transmitted by a respective one of the K transmitters 420 over a respective one of K channels, each of which has a channel impulse response h₁(n), h₂(n) . . . h_{K}(n). It should be noted that once again no cyclic prefix is added to the time domain OFDM signal blocks [xₖ(n),xₖ(n+1), . . . xₖ(n+P−1l)], which advantageously results in an elimination of or avoidance of bandwidth expansion characteristics of known systems.

The receiver 412 includes an antenna device 421 coupled to a receiver front end 422 (similar in function to the receiver front end 122) for receiving the K time domain OFDM signal blocks as received signal vectors r(n),r(n+1), . . . r(n+P−1). The receiver front end 422 is connected to a signal processor 423 at the receiver 412. The signal processor 423 includes a channel estimator for estimating the channel impulse response ĥ₁(n),ĥ₂(n) . . . ĥ_{K}(n) for each of the K channels that carried the K time domain OFDM signal blocks. The signal processor 423 further includes a tail cancellation and cyclic reconstruction device (tail cancellation device) 424 in communication with the channel estimator 426 for performing a first tail cancellation operation on the first received signal vector r(n) of the received signal and generating a first resultant signal \tilde{r}(n), and for performing a second tail cancellation operation on the remaining signal vectors (second block) [r(n+1), . . . r(n+P−1)] of the received signal for generating a second resultant signal block [\tilde{r}(n+1), . . . \tilde{r}(n+P−1)], and for restoring a cyclic property to the first resultant signal and second resultant signal block. The signal processor 423 includes a discrete Fourier transform (DFT) device 428 for performing a discrete Fourier transformation on the first resultant signal \tilde{r}(n) and the second resultant signal block [\tilde{r}(n+1), . . . \tilde{r}(n+P−1)] to generate a transformed first resultant signal and a transformed second resultant signal block, a space-time decoding device 430 for decoding the transformed first resultant signal and transformed second resultant signal block to generate an output block estimate [\hat{X}(n), \hat{X}(n+1), . . . \hat{X}(n+P−1)], a parallel to serial converter 432 for converting the final output block estimates to output serial data symbols, a memory source 434 for providing temporary storage of the output blocks, a space-time encoding device 436 for encoding an estimate of a previous output block [\hat{X}(n−P),\hat{X}(n−P+1), . . . \hat{X}(n−1)] to generate K encoded previous estimate blocks [\hat{X}₁(n−P),\hat{X}₁(−P+1), . . . \hat{X}₁(n−1)], . . . [\hat{X}ₖ(n−P),\hat{X}_{K}(n−P+1), . . . \hat{X}_{K}(n−1)], and for encoding the current estimate block [\hat{X}(n),\hat{X}(N+1), . . . \hat{X}(n−1)] to generate K encoded current estimate blocks [\hat{X}₁(n),\hat{X}₁(n+1), . . . \hat{X}₁(n+P−1)], . . . [\hat{X}_{K}(n),\hat{X}_{K}(n+1), . . . \hat{X}_{K}(n+P−1)], and an IDFT transform device 438 for performing an inverse discrete Fourier transformation on the encoded previous estimate block [\hat{X}ₖ(n−P),\hat{X}ₖ(n−P+1), . . . \hat{X}ₖ(n−1)] to generate a transformed previous estimate block [\hat{x}ₖ(n−P), \hat{x}ₖ(n−P+1), . . . \hat{x}ₖ(n−1)], and for performing the inverse discrete Fourier transformation on the encoded current estimate block [\hat{X}ₖ(n),\hat{X}ₖ(n+1), . . . \hat{X}ₖ(n+P−1)] to generate a transformed current estimate block [\hat{x}ₖ(n),\hat{x}ₖ(n+1), . . . \hat{x}ₖ(n+P−1)]. As appreciated by those skilled in the art, the receiver 412 will include further processing operations such as error decoding, interfacing, and the like for providing information suitable for consumption or utilization by a user or other entity requiring the information.

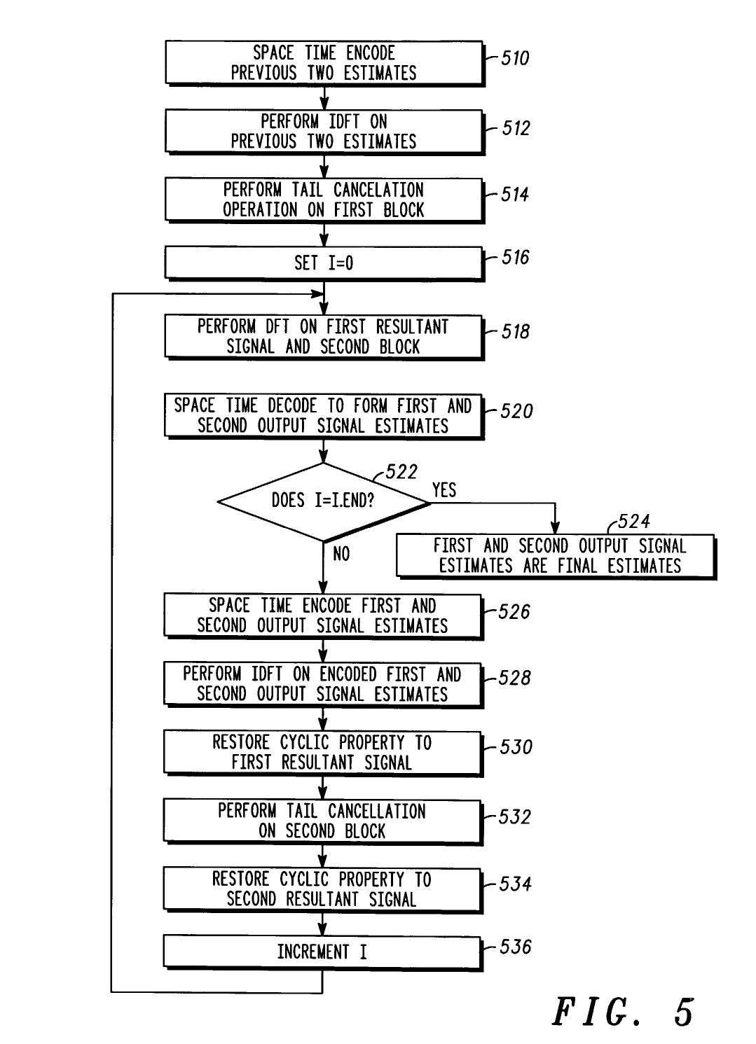

Operation of the receiver 412 will be referred to as Iterative Space Time Orthogonal Frequency Division Multiplexing (IST-OFDM) and will be more fully discussed with reference to FIGS. 4-5.

Initially, at 510 the ST encoding device 436 space-time encodes estimates of a previous output block [\hat{X}(n−P),\hat{X}(n−P+1), . . . \hat{X}(n−1)] stored in the memory 434 to generate K space-time encoded previous estimate blocks [\hat{X}₁(n−P),\hat{X}₁(n−P+1), . . . \hat{X}₁(n−1)], . . . [\hat{X}ₖ(n−P),\hat{X}ₖ(n−1), . . . \hat{X}ₖ(n−1)]. The ST encoding is performed in a manner similar to that of the ST encoder 416 of the space-time diversity transmitter 410.

At 512, the IDFT device 438 performs an inverse discrete Fourier transformation on the K space-time encoded previous estimate blocks [\hat{X}₁(n−P),\hat{X}₁(n−P+1), . . . \hat{X}₁(n−1)], . . . [\hat{X}_{K}(n−P),\hat{X}_{K}(n−P+1), . . . \hat{X}_{K}(n−1)] to generate K transformed previous estimate blocks [\hat{x}₁(n−P),\hat{x}₁(n−P+1), . . . \hat{x}₁(n−1)], . . . [\hat{x}_{K}(n−P),\hat{x}_{K}(n−P+1), . . . \hat{x}_{K}(n−1)], which are provided to the tail cancellation device 424 for the first tail cancellation operation.

At 514, the tail cancellation device 424 and the channel estimator 426 receive the K time domain OFDM signal blocks as received signal vectors [r(n), r(n+1), . . . r(n+P−1)]. The received signal vectors can be expressed mathematically in terms of convolution matrices and vectors by equation (4):

$$\begin{matrix}\begin{matrix}\begin{matrix}r ( n ) = {\sum }_{k = 1}^{K} {H}_{k , 0} {x}_{k} ( n ) + {H}_{k , 1} {x}_{k} ( n - 1 ) \\ r ( n + 1 ) = {\sum }_{k = 1}^{K} {H}_{k , 0} {x}_{k} ( n + 1 ) + {H}_{k , 1} {x}_{k} ( n )\end{matrix} \\ ⋮\end{matrix} \\ r ( n + P - 1 ) = r ( n ) = {\sum }_{k = 1}^{K} {H}_{k , 0} {x}_{k} ( n + p - 1 ) + {H}_{k , 1} {x}_{k} ( n + P - 2 )\end{matrix} \qquad ( 4 )$$

The symbology of equation (4) is similar to that of equation (1) and the convolution matrices of the channel impulse responses h₁(n), h₂(n) . . . hₖ(n) are similar to those shown above with respect to the ISF-OFDM process.

The channel estimator 426 estimates the channel impulse response ĥ₁(n),ĥ₂(n) . . . ĥₖ(n) for each of the K channels that carries the respective block of the K time domain OFDM signal blocks and determines the first and second convolution components for each of the estimated channel impulse responses in a manner similar to that of the channel estimator 126 of the ISF-OFDM system.

The tail cancellation device 424 performs the tail cancellation operation on the first block r(n) of the received signal vectors based upon the second convolution component for each of the estimated channel impulse responses for each of the plurality of channels determined by the channel estimator 426 and the K transformed previous estimates \hat{x}₁(n−1),\hat{x}₂(n−1) . . . \hat{x}ₖ(n−1) determined by the IDFT device 438 and generates a first resultant signal \tilde{r}(n). Generally, the tail cancellation device 424 performs the first tail cancellation operation on the first block of the received signal and generates the first resultant signal \tilde{r}(n) in accordance with equation (5):

$$\tilde{r} ( n ) = r ( n ) - {\sum }_{k = 1}^{K} {\hat{H}}_{k , 1} {\hat{x}}_{k} ( n - 1 ) \qquad ( 5 )$$

\tilde{r}(n) represents the first resultant signal, r(n) represents the first received signal block, Ĥ_{k,1} represents the second convolution component of the estimated channel impulse response for each of the K channels and \hat{x}₁(n−1),\hat{x}₂(n−1) . . . \hat{x}ₖ(n−1) represents the transformed previous estimate from the IDFT device 438.

At 516, the control iterator I is initialized to zero as discussed above with respect to the ISF-OFDM methodology. This control iterator I may also be stored, for example, in the tail cancellation device 424.

At 518, the DFT device 128 performs a discrete Fourier transformation on the first resultant signal \tilde{r}(n) and the block of remaining received signal vectors [r(n+1), . . . r(n+P−1)] to generate a transformed first resultant signal and a transformed second resultant signal block.

At 520, the space-time decoder 430 space-time decodes the transformed first resultant signal and transformed second resultant signal block to generate an output estimate block [\hat{X}(n),\hat{X}(n+1), . . . \hat{X}(n+P−1)]. These decoding operations are done in a manner that is the reverse of the ST encoder 416 and as discussed in “A Space-Time Coded Transmitter Diversity Technique for Frequency Selective Fading Channels” supra.

At 522, the control iterator I is checked to see if its value is I.END in a manner similar to that discussed above. If the value of the control iterator is I.END, the process proceeds to 524, where the output estimate block [\hat{X}(n),\hat{X}(n+1), . . . \hat{X}(n+P−1)] is treated as the final estimates and copies of this final estimate are stored in the memory 434 and forwarded to and processed by the parallel to serial device 432 to provide the output serial data. If the value of the control iterator is less than I.END, the process proceeds to 526.

At 526, the space-time encoding device 436 space-time encodes the output estimate block [\hat{X}(n),\hat{X}(n+1), . . . \hat{X}(n+P−1)] to generate K encoded output estimate blocks [\hat{X}₁(n),\hat{X}₁(n+1), . . . \hat{X}₁(n+P−1)], . . . [\hat{X}_{K}(n),\hat{X}_{K}(n+1), . . . \hat{X}_{K}(n+P−1)].

At 528, the IDFT device 438 performs the inverse discrete Fourier transformation on the K encoded output estimate blocks [\hat{X}₁(n),\hat{X}₁(n+1), . . . \hat{X}₁(n+P−1)], . . . [\hat{X}_{K}(n),\hat{X}_{K}(n+1), . . . \hat{X}_{K}(n+P−1)] to generate K transformed output estimate blocks [\hat{x}₁(n),\hat{x}₁(n+1), . . . \hat{x}₁(n+−1)], . . . [\hat{x}_{K}(n),\hat{X}_{K}(n+1), . . . \hat{X}_{K}(n+P−1)].

At 530, the tail cancellation device 424 restores the cyclic property to the first resultant signal in accordance with a first block cyclic restoration formula shown as equation (6):

$${y}^{( I )} ( n ) = \tilde{r} ( n ) + {\sum }_{k = 1}^{K} {\hat{H}}_{k , 1} {\hat{x}}_{k}^{( I )} ( n ) \qquad ( 6 )$$

y⁽ⁱ⁾(n) represents the first reconstructed output signal vector, and I represents the present iteration status of the control iterator for the predetermined number of iterations for which the reconstructed output signal vector is recalculated.

At 532, the tail cancellation device 424 performs the second tail cancellation operation in accordance with a second tail cancellation formula shown as equation (7):

$$\begin{matrix}\begin{matrix}\tilde{r} ( n + 1 ) = r ( n + 1 ) - {\sum }_{k = 1}^{K} {\hat{H}}_{k , 1} {\hat{x}}_{k} ( n ) \\ ⋮\end{matrix} \\ \tilde{r} ( n + P - 1 ) = r ( n + P - 1 ) - {\sum }_{k = 1}^{K} {\hat{H}}_{k , 1} {\hat{x}}_{k} ( n + P - 2 )\end{matrix} \qquad ( 7 )$$

where [\tilde{r}(n+1), . . . \tilde{r}(n+P−1)] represents the second resultant signal block, [r(n+1), . . . r(n+P−1)] represents the second block of the received signal, and [\hat{x}ₖ(n), . . . \hat{x}ₖ(n+P−2)] represents one of the K transformed output estimate blocks.

At 534, the tail cancellation device 424 restores the cyclic property to the second resultant signal block [\tilde{r}(n+1), . . . \tilde{r}(n+P−1)] in accordance with a second block restoration formula shown as equation (8):

$$\begin{matrix}\begin{matrix}{y}^{( I )} ( n + 1 ) = \tilde{r} ( n + 1 ) + {\sum }_{k = 1}^{K} {\hat{H}}_{k , 1} {\hat{x}}_{k}^{( I )} ( n + 1 ) \\ ⋮\end{matrix} \\ {y}^{( I )} ( n + P - 1 ) = \tilde{r} ( n + P - 1 ) + {\sum }_{k = 1}^{K} {\hat{H}}_{k , 1} {\hat{x}}_{k}^{( I )} ( n + P - 1 )\end{matrix} \qquad ( 8 )$$

[y⁽¹⁾(n+1), . . . y⁽¹⁾(n+P−1)] represent the second reconstructed output signal block and [\hat{x}ₖ⁽¹⁾(n+1), . . . \hat{x}ₖ⁽¹⁾(n+P−1)] represent one of the K transformed output estimate blocks.

At 536, the control iterator is incremented by one value and the process loops back to 518, where the first reconstructed output signal block y^{(I)}(n) is treated as the first resultant signal \tilde{r}(n) and the second reconstructed output signal block [y⁽¹⁾(n+1), . . . y⁽¹⁾(n+P−1)] is treated as the second resultant signal block [\tilde{r}(n+1), . . . \tilde{r}(n+P−1)]

From 518 the process repeats until I=I.END and 520 determines the final second output signal. The parallel to serial device 432 converts the final estimates to output serial data symbols. The graph of FIG. 6 shows the bit error rate obtained when using the IST-OFDM process of the present embodiment and also when using the conventional ST-OFDM technique with and without the cyclic prefix. As shown, the present embodiment provides a bit error rate that is comparable to that obtained with the conventional ST-OFDM technique with the cyclic prefix. However, the IST-OFDM advantageously obtains this bit error rate without the bandwidth expansion caused by the cyclic prefix.

Therefore, the present invention provides a system and method for providing iterative space-time and space frequency OFDM. The cyclic restoration and tail cancellation function performed by the tail cancellation and cyclic restoration device eliminates the need of a cyclic prefix in the transmitting devices. Consequently, bandwidth expansion in the transmitted symbols is eliminated. In addition, the use of the second convolution component of the estimated channel impulse response limits dependence on the channel responses.

Many of the various devices, functions or methods, discussed and described above, that are part of or performed by the receiver or transmitter are preferably and advantageously implemented by a digital signal processor arranged and constructed for executing software programs or instructions intended to run thereon or alternatively by hardware in integrated circuit form or a combination of both. In a preferred embodiment, the signal processor is a digital signal processor such as one of the DSP 56000 family of processors manufactured by Motorola, Inc.

While the above description is of the preferred embodiment, it should be appreciated that this embodiment may be modified, altered, or varied without deviating from the scope and fair meaning of the following claims. For example, the tail cancellation and cyclic restoration device could be provided as two separate devices.

In addition to the above incorporations by reference, the publication entitled “Bandwidth Efficient OFDM Transmitter Diversity Techniques” from the IEEE International Conference on Acoustics, Speech, and Signal Processing in Orlando, Fla. on May, 2002 and authored by Lee et al. (the inventors of the present invention) and the unpublished article also entitled “Bandwidth Efficient OFDM Transmitter Diversity Techniques” authored by Lee et al., and submitted concurrently with the present application are hereby incorporated by reference.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A diversity receiver comprising:
a receiver front end for receiving a plurality of time domain orthogonal frequency division multiplexed signals from a plurality of respective transmitting devices to provide a received signal; and
a signal processor coupled to the receiver front end for restoring a cyclic property to the received signal and for providing an output signal corresponding to the received signal.

2. The diversity receiver of claim 1, wherein the signal processor further includes a cyclic reconstruction device for restoring the cyclic property to the received signal based on a channel impulse response and an estimate of the output signal.

3. The diversity receiver of claim 2, wherein the signal processor includes:
a channel estimator for estimating the channel impulse response for each of a plurality of channels that carry the plurality of time domain orthogonal frequency division multiplexed signals, respectively;
a tail cancellation device in communication with the channel estimator, the tail cancellation device for performing a tail cancellation operation corresponding to the channel impulse response for each of the plurality of channels that carry the plurality of time domain orthogonal frequency division multiplexed signals on the received signal to provide a resultant signal;
a discrete Fourier transform device for performing a discrete Fourier transformation on the resultant signal to generate a transformed resultant signal; and
a space-frequency decoding device for decoding the transformed resultant signal to generate the estimate of the output signal.

4. The diversity receiver of claim 3, wherein the signal processor further includes:
a space-frequency encoding device for encoding one or more estimates of the output signal to generate a number of encoded estimates; and
an inverse discrete Fourier transform device for performing an inverse discrete Fourier transformation on the number of encoded estimates of the output signal to provide a number of transformed estimates to the tail cancellation device to facilitate the tail cancellation operation and to the cyclic reconstruction device to facilitate the restoring the cyclic property.

5. The diversity receiver of claim 4, wherein the cyclic reconstruction device is further for restoring the cyclic property to the resultant signal to provide a reconstructed signal to the discrete Fourier transform device and the space-frequency decoding device for use in generating an update estimate of the output signal.

6. The diversity receiver of claim 4, wherein the tail cancellation device is further for performing the tail cancellation operation in accordance with a tail cancellation formula that follows:
$$\tilde{r} ( n ) = r ( n ) - {\sum }_{k = 1}^{K} {\hat{H}}_{k , 1} {\hat{x}}_{k} ( n - 1 )$$
wherein \tilde{r}(n) represents the resultant signal, wherein r(n) represents the received signal, wherein Ĥ_{k,1} represents a convolution component of the channel impulse response for one of the plurality of channels that carries a respective one of the plurality of time domain orthogonal frequency division multiplexed signals, wherein \hat{x}ₖ(n−1) represents the number of transformed previous estimates, and wherein K represents a sum of the plurality of time domain orthogonal frequency division multiplexed signals.

7. The diversity receiver of claim 6, wherein the cyclic reconstruction device is further for restoring the cyclic property to the resultant signal in accordance with a cyclic restoration formula that follows:
$${y}^{( I )} ( n ) = \tilde{r} ( n ) + {\sum }_{k = 1}^{K} {\hat{H}}_{k , 1} {\hat{x}}_{k}^{I} ( n )$$
wherein y^{(I)}(n) represents a reconstructed signal, wherein \hat{x}ₖ⁽¹⁾(n) represents a transformed estimate and wherein I represents an iterative status of a predetermined number of iterations for which the reconstructed signal is recalculated.

8. The diversity receiver of claim 2, wherein:
the receiver front end is further for providing the received signal to include at least a first signal and a second signal;
the signal processor is further for providing the output signal to include at least a first reconstructed signal and a second reconstructed signal, the signal processor further including:
a channel estimator for estimating a channel impulse response for each of a plurality of channels that carry the plurality of time domain orthogonal frequency division multiplexed signals, respectively;
a tail cancellation device in communication with the channel estimator, the tail cancellation device for performing a first tail cancellation operation corresponding to the channel impulse response for each of the plurality of channels that carry the plurality of time domain orthogonal frequency division multiplexed signals on the first signal of the received signal to provide a first resultant signal;
a discrete Fourier transform device for performing a discrete Fourier transformation on the first resultant signal and the second signal to generate a transformed first resultant signal and a transformed second signal; and
a space-time decoding device for decoding the transformed first resultant signal and the transformed second signal to generate an output block estimate.

9. The diversity receiver of claim 8, wherein the signal processor further includes:
a space-time encoding device for encoding one or more estimates of the output signal to generate a number of encoded estimates; and
an inverse discrete Fourier transform device for performing an inverse discrete Fourier transformation on the number of encoded estimates to provide a number of transformed estimates to the tail cancellation device to facilitate the first tail cancellation operation and to the cyclic reconstruction device to facilitate the restoring the cyclic property.

10. The diversity receiver of claim 9, wherein:
the tail cancellation device performs the first tail cancellation operation based upon the number of transformed previous estimates and the channel impulse response for each of the plurality of channels; and
the tail cancellation device is further for performing a second tail cancellation operation on the second signal of the received signal for generating a second resultant signal.

11. The diversity receiver of claim 10, wherein the cyclic reconstruction device is further for restoring the cyclic property to the first resultant signal and the second resultant signal, and for generating the first reconstructed signal block and the second reconstructed signal block.

12. The diversity receiver of claim 11, wherein:
the tail cancellation device is further for performing the first tail cancellation operation in accordance with a first tail cancellation formula that follows:
$$\tilde{r} ( n ) = r ( n ) - {\sum }_{k = 1}^{K} {\hat{H}}_{k , 1} {\hat{x}}_{k} ( n - 1 )$$
wherein \tilde{r}(n) represents the first resultant signal, wherein r(n) represents the first signal, wherein Ĥk_{k,1} represents a convolution component of the channel impulse response for each of the plurality of channels, wherein \hat{x}ₖ(n−1) represents a transformed previous estimate, and wherein K represents a total number of the plurality of time domain orthogonal frequency division multiplexed signals; and
the tail cancellation device is further for performing the second tail cancellation operation in accordance with a second tail cancellation formula that follows:
$$\begin{matrix}\tilde{r} ( n + 1 ) = r ( n + 1 ) - {\sum }_{k = 1}^{K} {\hat{H}}_{k , 1} {\hat{x}}_{k} ( n ) \\ ⋮ \\ \tilde{r} ( n + P - 1 ) = r ( n + P - 1 ) - {\sum }_{k = 1}^{K} {\hat{H}}_{k , 1} {\hat{x}}_{k} ( n + P - 2 )\end{matrix}$$
wherein \tilde{r}(n+1), . . . \tilde{r}(n+P−1) represents the second resultant signal, wherein r(n+1), . . . r(n+P−1) represents the second signal of the received signal, and wherein \hat{x}ₖ(n), . . . \hat{x}ₖ(n+P−2) represents a transformed first output block estimate.

13. The diversity receiver of claim 12, wherein:
the cyclic reconstruction device is further for restoring the cyclic property to the first resultant signal in accordance with a first block cyclic restoration formula that follows:
$${y}^{( I )} ( n ) = \tilde{r} ( n ) + {\sum }_{k = 1}^{K} {\hat{H}}_{k , 1} {\hat{x}}_{k}^{I} ( n )$$
wherein y⁽ⁱ⁾(n) represents the first reconstructed signal, and wherein i represents an iterative status of a predetermined number of iterations for which the first reconstructed output signal is recalculated; and
the cyclic reconstruction device is further for restoring the cyclic property to the second resultant signal in accordance with a second block restoration formula that follows:
$$\begin{matrix}{y}^{( I )} ( n + 1 ) = \tilde{r} ( n + 1 ) + {\sum }_{k = 1}^{K} {\hat{H}}_{k , 1} {\hat{x}}_{k}^{( I )} ( n + 1 ) \\ ⋮ \\ {y}^{( I )} ( n + P - 1 ) = \tilde{r} ( n + P - 1 ) + {\sum }_{k = 1}^{K} {\hat{H}}_{k , 1} {\hat{x}}_{k}^{( I )} ( n + P - 1 )\end{matrix}$$
wherein y⁽ⁱ⁾(n+1), . . . y⁽ⁱ⁾(n+P−1) represents the second reconstructed signal and wherein \hat{x}ₖ⁽ⁱ⁾(n+1), . . . \hat{x}ₖ⁽ⁱ⁾N+P−1) represents a transformed second output block estimate.

14. A method for recovering a diversity transmitted signal comprising:
receiving a plurality of time domain orthogonal frequency division multiplexed signals to provide a received signal;
estimating a channel impulse response for each of a plurality of channels that carry the plurality of time domain orthogonal frequency division multiplexed signals, respectively; and
restoring a cyclic property to the received signal according to the channel impulse response for each of the plurality of time domain orthogonal frequency division multiplexed signals to provide a reconstructed output signal.

15. The method of claim 14, wherein the restoring a cyclic property to the received signal according to the channel impulse response for each of the plurality of time domain orthogonal frequency division multiplexed signals to provide a reconstructed output signal further includes restoring the cyclic property to the received signal based on an estimate of an output signal.

16. The method of claim 15, further including:
performing a tail cancellation operation on the received signal for generating a resultant signal and the restoring a cyclic property to the received signal according to the channel impulse response for each of the plurality of time domain orthogonal frequency division multiplexed signals to provide a reconstructed output signal is performed on the resultant signal;
wherein the performing a tail cancellation operation further comprises:
space-frequency encoding the estimate of the output signal to generate an encoded estimate;
performing an inverse discrete Fourier transformation on the encoded estimate of the output signal to generate a transformed estimate; and
performing the tail cancellation operation based upon the transformed estimate and the channel impulse response for each of a plurality of channels.

17. The method of claim 16, wherein the restoring a cyclic property to the resultant signal to provide a reconstructed signal further comprises:
performing a discrete Fourier transformation on the resultant signal to generate a transformed resultant signal;
space-frequency decoding the transformed resultant signal to generate the estimate of the output signal;
space-frequency encoding a plurality of estimates of the output signal to generate a plurality of encoded estimates;
performing an inverse discrete Fourier transformation on the plurality of encoded estimates to generate a plurality of transformed estimates; and
restoring the cyclic property to the resultant signal in accordance with the plurality of transformed estimates and the channel impulse response for each of the plurality of channels.

18. The method of claim 14, wherein the performing a tail cancellation operation on the received signal for generating a resultant signal further comprises performing the tail cancellation operation in accordance with a tail cancellation formula that follows:
$$\tilde{r} ( n ) = r ( n ) - {\sum }_{k = 1}^{K} {\hat{H}}_{k , 1} {\hat{x}}_{k} ( n - 1 )$$
wherein \tilde{r}(n) represents the resultant signal, wherein r(n) represents the received signal, wherein Ĥ_{k,1} represents a convolution component of the channel impulse response for one of the plurality of channels that carries a respective one of the plurality of time domain orthogonal frequency division multiplexed signals, wherein \hat{x}ₖ(n−1) represents a number of transformed previous estimates, and wherein K represents a sum of the plurality of time domain orthogonal frequency division multiplexed signals.

19. The method of claim 18, wherein the restoring a cyclic property in the resultant signal for generating a reconstructed signal further comprises restoring the cyclic property to the resultant signal in accordance with a cyclic restoration formula that follows:
$${y}^{( I )} ( n ) = \tilde{r} ( n ) + {\sum }_{k = 1}^{K} {\hat{H}}_{k , 1} {\hat{x}}_{k}^{I} ( n )$$
wherein y^{(l)}(n) represents the reconstructed signal, wherein \hat{x}ₖ^{(l)}(n) represents a transformed estimate and wherein I represents an iterative status of a predetermined number of iterations for which the reconstructed signal is recalculated.

20. A method for recovering a diversity transmitted signal comprising:
receiving a plurality of time domain orthogonal frequency division multiplexed signals to provide a first received signal and a second received signal;
estimating a channel impulse response for each of a plurality of channels that carry the plurality of time domain orthogonal frequency division multiplexed signals, respectively;
performing a first tail cancellation operation on the first received signal for generating a first resultant signal;
performing a second tail cancellation operation on the second received signal for generating a second resultant signal; and
restoring a cyclic property to the first received signal and the second received signal according to the channel impulse response for each of the plurality of channels that carry the plurality of time domain orthogonal frequency division multiplexed signals to provide a first reconstructed signal and a second reconstructed signal.

21. The method of claim 20, wherein the performing a first tail cancellation operation on the first received signal for generating a first resultant signal further comprises:
space-time encoding an estimate of a previous output signal to generate a number of encoded previous estimates; and
performing an inverse discrete Fourier transformation on the number of encoded previous estimates to generate a number of transformed previous estimates; and
performing the first tail cancellation operation based upon the number of transformed previous estimates and the channel impulse response for each of the plurality of channels.

22. The method of claim 21, wherein the performing a second tail cancellation operation on the second received signal for generating a second resultant signal further comprises:
space-time encoding a first output block estimate to generate a number of encoded first output block estimates;
performing the inverse discrete Fourier transformation on the number of encoded first output block estimates to generate a number of transformed first output block estimates; and
performing the second tail cancellation operation based upon number of transformed first output block estimates and the channel impulse response for each of the plurality of channels.

23. The method of claim 22, wherein the restoring a cyclic property to the first resultant signal and the second resultant signal for generating a first reconstructed signal and a second reconstructed signal further comprises:
performing the inverse discrete Fourier transformation on the number of encoded second block estimates to generate a number of transformed second output block estimates;
restoring the cyclic property to the first resultant signal in accordance with the number of transformed first output block estimates and the channel impulse response for each of the plurality of channels; and
restoring the cyclic property to the second resultant signal in accordance with the number of transformed first output block estimates and the channel impulse response for each of the plurality of channels.

24. The method of claim 20, wherein the performing a first tail cancellation operation on the first received signal for generating a first resultant signal further comprises performing the first tail cancellation operation in accordance with a first tail cancellation formula that follows:
$$\tilde{r} ( n ) = r ( n ) - {\sum }_{k = 1}^{K} {\hat{H}}_{k , 1} {\hat{x}}_{k} ( n - 1 )$$
wherein \tilde{r}(n) represents the first resultant signal, wherein r(n) represents the first received signal, wherein Ĥ_{k,1} represents a convolution component of the channel impulse response for each of the plurality of channels, wherein \hat{x}ₖ(n−1) represents a transformed previous estimate, and wherein K represents a total number of the plurality of time domain orthogonal frequency division multiplexed signals.

25. The method of claim 24, wherein the performing a second tail cancellation operation on the second received signal for generating a second resultant signal further comprises performing the second tail cancellation operation in accordance with a second tail cancellation formula that follows:
$$\begin{matrix}\tilde{r} ( n + 1 ) = r ( n + 1 ) - {\sum }_{k = 1}^{K} {\hat{H}}_{k , 1} {\hat{x}}_{k} ( n ) \\ ⋮ \\ \tilde{r} ( n + P - 1 ) = r ( n + P - 1 ) - {\sum }_{k = 1}^{K} {\hat{H}}_{k , 1} {\hat{x}}_{k} ( n + P - 2 )\end{matrix}$$
wherein \tilde{r}(n+1), . . . \tilde{r}(n+P−1) represents the second resultant signal, wherein r(n+1), . . . r(n+P−1) represents the second received signal, and wherein \hat{x}ₖ(n), . . . \hat{x}ₖ(n+P−2) represents a transformed first output block estimate.

26. The method of claim 25, wherein the restoring a cyclic property to the first received signal and the second received signal according to the channel impulse response for each of the plurality of channels that carry the plurality of time domain orthogonal frequency division multiplexed signals to provide a first reconstructed signal and a second reconstructed signal further comprises:
restoring the cyclic property to the first signal in accordance with a first block cyclic restoration formula that follows:
$${y}^{( I )} ( n ) = \tilde{r} ( n ) + {\sum }_{k = 1}^{K} {\hat{H}}_{k , 1} {\hat{x}}_{k}^{( I )} ( n )$$
wherein y^{(I)}(n) represents the first reconstructed signal, and wherein I represents an iterative status of a predetermined number of iterations for which the first reconstructed output signal block is recalculated; and
restoring the cyclic property to the second resultant signal in accordance with a second block cyclic restoration formula that follows:
$$\begin{matrix}{y}^{( I )} ( n + 1 ) = \tilde{r} ( n + 1 ) + {\sum }_{k = 1}^{K} {\hat{H}}_{k , 1} {\hat{x}}_{k}^{( I )} ( n + 1 ) \\ ⋮ \\ {y}^{( I )} ( n + P - 1 ) = \tilde{r} ( n + P - 1 ) + {\sum }_{k = 1}^{K} {\hat{H}}_{k , 1} {\hat{x}}_{k}^{( l )} ( n + P - 1 )\end{matrix}$$
wherein y^{(l)}(n+1), . . . y⁽¹⁾(n+P−1) represents the second reconstructed signal and wherein \hat{x}ₖ^{(l)}(n+1), . . . \hat{x}ₖ^{(l)}(n+P−1) represents a transformed second output block estimate.

27. A system for providing diversity transmissions comprising:
a device for transmitting synchronized time domain orthogonal frequency division multiplexed signals, the device comprising an encoding device for encoding codes into vectors according to a predetermined coding scheme, a plurality of inverse discrete Fourier transform device, for performing a transformation on the vectors and for generating a plurality of time domain orthogonal frequency division multiplexed signals, and a plurality of transmitters for transmitting the plurality of time domain orthogonal frequency division multiplexed signals, respectively; and
a receiver for receiving the plurality of time domain orthogonal frequency division multiplexed signals, the receiver including a signal processor for restoring a cyclic property in the plurality of time domain orthogonal frequency division multiplexed signals and for generating an output signal.
